(19) United States
(12) Patent Application Publication
(10) Pub. No.: US 2003/0046818 A1
(43) Pub. Date: Mar. 13, 2003

(54) Folding knife with a blade thumb guard

(76) Inventor: Louis S. Glesser, Golden, CO (US)

Correspondence Address: SHERIDAN ROSS PC, 1560 BROADWAY, SUITE 1200, DENVER, CO, 80202

(21) Appl. No.: 09/954,660

(22) Filed: Sep. 12, 2001

(51) Int. Cl. B26B 1/04; B26B 29/02

(52) U.S. Cl. 30/161; 30/295

(57) ABSTRACT

A blade is provided which has a shroud extending outwardly from an upper edge of said knife blade for engaging a user's thumb during use, and for assisting a user to open said knife blade when interconnected to a folding knife handle.

### FIELD OF THE INVENTION

The following invention relates to cutting instruments and more specifically to knife blades and folding knife blades.

### BACKGROUND OF THE INVENTION

Cutting instruments, and more specifically hand-held knives, are well known and have been used extensively by hunters, fisherman, carpenters, policemen and others who require a sharpened cutting instrument. Folding knives have become especially popular because the knife blade can be folded to store the cutting edge of the blade within a handle cavity. This feature allows the folding knife to be compact and occupy approximately 50% less space as a similar sized fixed blade knife.

One problem with folding knives is the difficulty opening the knife blade from a closed position to an extended position of use. Although various knife manufacturers have now begun to manufacture the blades with “thumb studs”, various shaped apertures and depressions for opening the knife blade, many individuals still have a difficult time opening their folding knives, especially while wearing gloves, or those having large hands. Further, many thumb studs and depressions are often only provided on one side, thus not making the folding knife suitable for ambidextrous use.

Furthermore, once the knife blade is extended for cutting purposes, many users find the folding knife uncomfortable to use due to thin upper edge of the blade when it interconnects to the handle. Thus, whenever a cutting stroke is performed, the upper edge of the knife blade often digs into a users' thumb, which is extremely uncomfortable after extended periods of use. Further, during the cutting motion the thumb often slides forward along the upper edge of the knife blade, which is not only inefficient but potentially dangerous. This problem exists for both folding knife blades and more traditional fixed blade knives which are commonly used for hunting and in the kitchen for slicing and dicing vegetables, meat and other food products.

Thus, it would be extremely beneficial to have a folding knife blade which has a shroud positioned near the upper edge to help facilitate opening of the knife blade and to provide a protective lip to support a user's thumb during use. These and other features are discussed hereinbelow.

### SUMMARY OF THE INVENTION

It is thus one aspect of the present invention to provide a folding knife which can be opened with one hand, and is ambidextrous for opening by either a left handed or right handed user. Thus, in one embodiment of the present invention a folding knife is provided which is generally comprised of a handle and a blade which is rotatably interconnected to a forward end of the handle. The blade is generally comprised of a front end, a heel end, a sharpened cutting edge and an upper edge. In an extended position of use, the blade is substantially an extension of the handle, while in a closed position of storage the cutting edge of the blade is positioned within a cavity of the handle for safety. To accommodate both right and left handed opening, a shroud is integrally interconnected to an upper edge of the knife blade proximate to the knife handle, and extends outwardly at substantially a right angle in both the right and left handed directions. Thus, as a user's thumb moves upward along the blade toward the upper edge, it engages a lower edge of the shroud, which rotates the knife blade upwardly into an extended position of use. Thus, in one embodiment of the present invention, a folding knife is provided with a blade shroud which extends outwardly from an upper edge of the knife blade on each side of a blade upper edge at least about 0.15 inches.

It is a further aspect of the present invention to provide a support mechanism on a knife blade for a user's thumb to eliminate finger fatigue during certain cutting strokes. The blade may be adapted for used with a folding knife or a fixed bladed knife to serve substantially the same purpose of providing support to a user's thumb while cutting. Thus, in one embodiment of the present invention the aforementioned shroud positioned along an upper edge of the knife blade has a width substantially about the width of the knife handle to provide support for the user's thumb. Alternatively, the shroud has a width at least about three times the width of an upper edge of the knife blade. In a preferred embodiment the upper edge of the shroud is serrated to prevent slipping of a user's thumb. Thus, in one embodiment of the present invention a knife blade is provided which is adapted or use with a knife handle, and which comprises:

a pointed end, a heel end, a cutting edge and an upper end, said heel end adapted for rotatable interconnection to a forward end of the folding knife handle;

a hump extending upwardly from said upper edge of said knife blade between said pointed end and said heel end;

a shroud integrally interconnected to said upper edge of said knife blade proximate to said hump and extending outwardly in at least two opposite directions from said upper edge to create a width at least about three times a thickness of the knife blade, wherein a user's thumb is positioned against a lower surface of said shroud during opening of said knife blade and on an upper surface of said knife blade when said knife blade is an extended position of use.

In another embodiment of the present invention, a folding knife with an integral blade thumb guard is provided and which comprises:

a handle having a front end, a rear end, an upper end and a lower end, and a cavity extending therebetween;

a blade having a pointed end, a heel end, an upper edge and a cutting edge, said heel end rotatably interconnected to said forward end of said handle, wherein said knife blade can be rotated between a closed position with said cutting edge positioned substantially within said cavity, and an extended position wherein said blade is substantially an extension of said handle;

a shroud interconnected to said upper edge of said blade proximate to said heel end, said shroud extending outwardly in at least two opposite directions from said upper edge to provide a protective shelf for a user's thumb when said knife blade is in said extended position of use, and to facilitate opening with a user's thumb when said folding knife blade is in said closed position.

### BRIEF DESCRIPTION OF THE DRAWINGS

FIG. 1 is a front elevation view of one embodiment of the present invention shown with the blade in an extended position of use;

FIG. 2 is a top plan view of the embodiment shown in FIG. 1 and identifying the blade shroud;

FIG. 3 is a rear elevation view of an alternative embodiment of the present invention and identifying a handle clip;

FIG. 4 is a top plan view of the invention shown in FIG. 3;

FIG. 5 is a front elevation view of the invention shown in FIG. 1 shown with the blade in a closed position and having an alternative blade depression as opposed to a blade aperture;

FIG. 6 is a top plan view of one embodiment of a shroud; and

FIG. 7 is a front elevation view of the shroud shown in FIG. 6.

### DETAILED DESCRIPTION

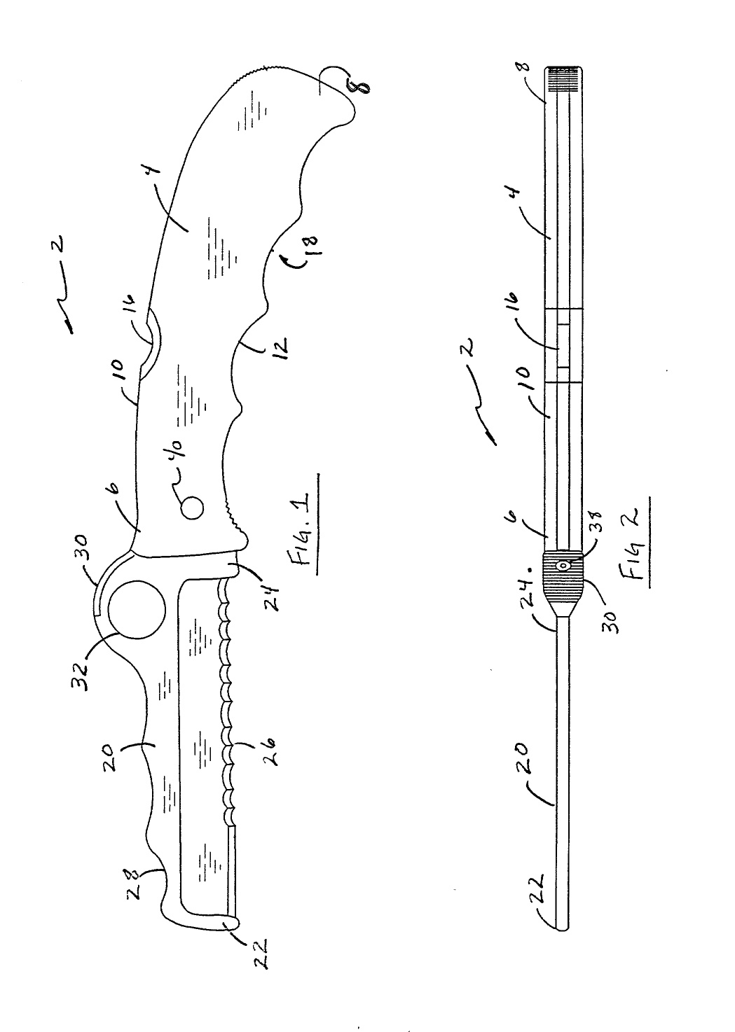

Referring now to the drawings, FIGS. 1-7 depict various embodiments and aspects of the present invention. More specifically, FIG. 1 is a front elevation view of a folding knife. In general, the folding knife 2 comprises a handle with a front end 6, a rear end 8, a handle upper end 10, and a handle lower end 12. The handle lower end 12 is further defined by a handle cavity 18, which receives the blade 20 when the blade is in a closed position such as shown in FIG. 5. Typically the handle cavity 18 is created by a front “scale” being interconnected to a back “scale” with a spacer positioned therebetween, and interconnected by rivets, screws, glue or other means for interconnection.

The blade 20 of the folding knife is pivotally interconnected to the handle front end 6 at a blade pivot point 40, which is generally comprised of a rivet or other type of metallic pin upon which the blade rotates. Although not shown in the drawings, the present invention may also be used on the blade 20 of a “fixed blade” knife, where the blade 20 is not capable of rotating about an axis positioned on the front end 6 of the knife handle.

The blade 20 is generally comprised of a blade pointed end 22, a blade heel end 24, a blade cutting edge 26, and a blade upper edge 28. As further shown in FIG. 1, a blade aperture 32 may additionally be provided to allow a user to engage a thumb or finger in the aperture to assist opening the blade from a closed position of use to an extended position of use as shown in FIG. 1. Although the blade aperture 32 in FIG. 1 is shown as a circle, as appreciated by one skilled in the art the blade aperture 32 may have the geometric configuration of an oval, diamond, rectangle, or any other geometric configuration which allows engagement to a user's thumb or finger. As an alternative to the blade aperture 32 shown in FIG. 1, a blade depression 34 may be utilized as shown in FIG. 5. The blade depression 34 is distinguished from the blade aperture 32 since the aperture does not extend entirely through the thickness of the blade 20, but rather provides a position for engagement of a user's thumb and may or may not include serrations for frictional engagement.

In an alternative embodiment of the present invention a training knife may be provided which has a blade without a sharpened edge or pointed end, and thus can be used in training without any significant danger of cutting the user or a participant in a training exercise. In this embodiment the blade cutting edge is referred to as a “blade lower edge” and the blade pointed end is referred to as the “blade front end”.

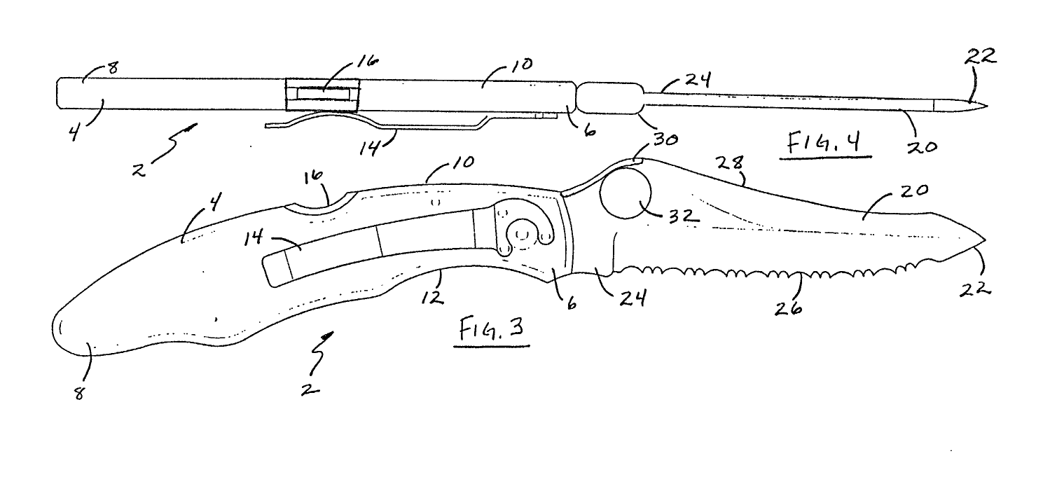

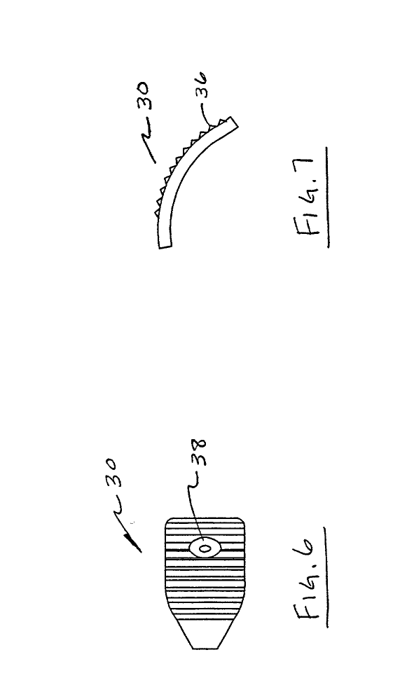

Referring now to FIG. 2, the folding knife of FIG. 1 is shown in a top plan view. In this drawing, the blade shroud 30 is shown in greater detail and with respect to the relationship between the blade 20 and the handle front end 6. More specifically, in one embodiment the blade shroud 30 is designed to extend from the blade heel end 24 in a forward direction toward the upper most portion of the hump in the blade 20. A top plan view of the shroud shown in FIG. 2 may additionally be seen in FIG. 6, as well as in the front elevation view in FIG. 7. Alternatively, the blade shroud may only extend within a portion of the distance between the handle forward end 6 and the uppermost portion of the hump in the blade 20.

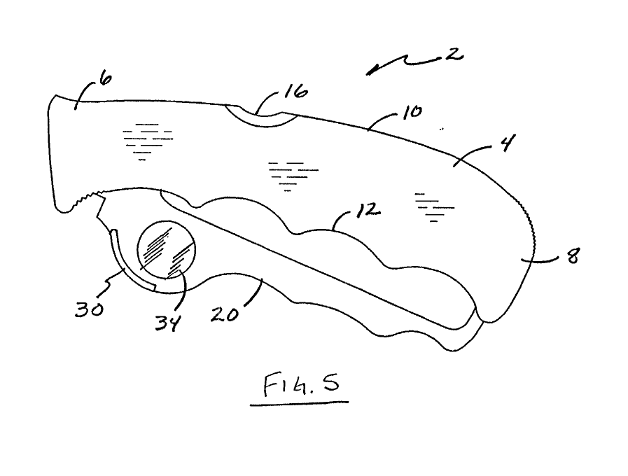

As seen in FIGS. 6 and 7, the shroud in one embodiment may have a substantially triangular shape on the forward end of the shroud, and a substantially rectangular shape on the rearward end. Alternatively, the shroud may have a substantially oval shape as shown in FIGS. 3 and 4, or any other shape which provides a sufficient cross sectional area for engagement to a user's thumb. Preferably, the shroud is integrally interconnected to the blade 20 and is thus manufactured at the same time as the blade 20. Alternatively, and as shown in FIG. 6, a shroud screw 38 may be provided to interconnect the shroud 30 to the blade upper edge after the manufacturing of the blade 20. In a preferred embodiment shown in FIGS. 6-7, the shroud has a plurality of shroud serrations 36 which extend outwardly from the shroud 30 and which are used to provide frictional engagement to a user's thumb and hence prevent slipping. Furthermore, the shroud in one embodiment may have a substantially arcuate shape to follow the geometric shape of the hump positioned along the blade upper edge 28. Alternatively, other geometric shapes of the shroud and associated hump are possible including straight lines, angular shapes and other configurations which allow a user's thumb to be positioned against the shroud and preferably in a configuration which provides support against the thumb and prevents slipping.

The shroud is operably positioned and designed to accomplish two primary purposes. First, when opening a folding knife from a closed position of use to an extended position of use, the shroud 30 engages a user's thumb in combination with the blade aperture 32 and/or blade depression 34. Thus, it is significantly easier for a user to open the blade 20, even while using gloves or for a user which has particularly large hands. Alternatively, the shroud 30 may be used independently and without either a blade aperture 32 or blade depression 34.

Secondly, the shroud 30 is used to support a user's thumb when the blade 20 is in a first extended position of use, and pressure is applied downward to the blade 20 by means of a user's hand and thumb which in a normal position of use is resting on an upper-most portion of the shroud 30. The shroud thus prevents excessive finger and hand fatigue during extended periods of use, and further substantially prevents the potentially dangerous result of a user's thumb slipping downward toward the blade cutting edge 26, and provides significantly more stability for a user during skinning or other cutting operations. Thus, the shroud 30 is utilized in both the opening of a folding knife blade 20, from a closed position of use to a first extended position, and is additionally used throughout a cutting motion when the user applies thumb pressure on the upper-most portion of the shroud 30. Thus, the benefit associated with providing support for a user's thumb applies also to fixed blade, non-folding knives.

Referring now to FIG. 3, a rear front elevation view of an alternative embodiment of the present invention is shown. In this embodiment, a clip 14 is interconnected to the handle 4 and which allows the folding knife 2 to be removably interconnected to a user's clothing such as a belt, pocket or other object. As further identified in FIG. 3 and FIG. 4, an alternatively shaped blade 20 is provided, as well as a blade locking mechanism 16 which is used to release the blade 20 from the extended position of use to a closed position wherein the blade 20 rotates downwardly and the blade cutting edge 26 is received into the handle cavity 18.

Although the blade locking mechanism 16 shown in FIG. 3 and FIG. 4 is released by applying downward finger pressure and thus releasing a biased tang engaged with the blade heel end 24, various other types of blade locking mechanisms may be used for the same purpose including liner locks, rolling locks, and other locking mechanisms commonly known in the art.

As further seen in FIG. 4, the shroud 30 in this embodiment comprises a substantially oval shape, although any other type of geometric configuration which provides sufficient surface area for a user's thumb may be used. Preferably the shroud 30 has a width which is at least about three times the width of the knife blade. In an alternative embodiment, the shroud may have a width substantially about the same as the width of a knife handle, thus providing a smooth transition for a user's thumb as it moves from the handle upper edge 10 to the blade upper edge 28. As previously mentioned, in another embodiment the blade upper edge 28 may have a “hump” extending upwardly from the knife handle upper edge 10 and extending above the knife depression 32, and which provides additional support for a user's thumb, especially when used in combination with the blade shroud 30. Thus the combination of the blade aperture 32, the hump in the blade, and the shroud 30 provide a knife blade which is significantly easier to use both in the opening of the knife blade and during cutting operations.

The foregoing description of the present invention has been presented for purposes of illustration and description. Furthermore, the description is not intended to limit the invention to the form disclosed herein. Consequently, variations and modifications of the invention described herein and the skill or knowledge of the relevant art are within the scope of the present invention. The embodiments described herein above are further extended to explain best modes known for practicing the invention and to enable others skilled in the art to utilize the invention in such, or other, embodiments or various modifications required by the particular applications or uses of the present invention. It is intended that the dependent claims be construed to include all possible embodiments to the extent permitted by the prior art.

For clarity, the following list of components and associated numbering found in the drawings are provided herein:

No. Component

2 Folding knife

4 Handle

6 Handle front end

8 Handle rear end

10 Handle upper end

12 Handle lower end

14 Clip

16 Blade locking mechanism

18 Handle cavity

20 Blade

22 Blade pointed end

24 Blade heel end

26 Blade cutting edge

28 Blade upper edge

30 Shroud

32 Blade aperture

34 Blade depression

36 Shroud serrations

38 Shroud screw

40 Blade pivot point

What is claimed is:

1. A knife blade with integral thumb guard, comprising:
a pointed end, a cutting edge, an upper edge and a heel end adapted for interconnection to a handle; and
a shroud interconnected to said upper edge of said knife blade proximate to said heel end and extending outwardly on opposite sides from said upper edge at substantially right angles to a plane occupied by said knife blade, wherein a user of said knife blade can position their thumb on an upper surface of said shroud while using said knife blade for cutting, and on a lower surface of said shroud to assist opening said blade when said cutting edge of said knife blade is positioned within a cavity of the handle of a folding knife.

2. The knife blade of claim 1, wherein said upper surface of said shroud comprises a plurality of serrations for frictionally engaging the thumb of said user.

3. The knife blade of claim 1, wherein said shroud extends outwardly from the upper edge of said knife blade at least about 0.15 inches on each side of said upper edge.

4. The knife blade of claim 1, further comprising an aperture extending through said knife blade substantially below said shroud for engaging a users thumb during opening of said knife blade.

5. The knife blade of claim 1, further comprising a depression positioned substantially below said shroud for engaging a user's thumb during opening of said knife blade when said knife blade is rotatably interconnected to the handle.

6. The knife blade of claim 1, wherein said cutting edge is serrated.

7. The knife blade of claim 1, wherein said shroud has a substantially rectangular shape.

8. The knife blade of claim 1, wherein said shroud has a substantially oval shape.

9. The knife blade of claim 1, wherein said shroud has a width extending outwardly from said upper edge of said knife blade substantially about the width of the folding knife handle.

10. The folding knife blade of claim 1, wherein said knife blade has a hump extending upwardly from said upper edge of said knife blade at a position substantially below said shroud.

11. The folding knife blade of claim 1, wherein said shroud has a substantially triangular shape.

12. The folding knife of blade of claim 1, wherein said shroud has a width at least about three times as wide as a width of said upper edge of said knife blade.

13. A folding knife with an integral blade thumb guard, comprising:
a handle having a front end, a rear end, an upper end and a lower end, and a cavity extending therebetween;
a blade having a pointed end, a heel end, an upper edge and a cutting edge, said heel end rotatably interconnected to said forward end of said handle, wherein said knife blade can be rotated between a closed position with said cutting edge positioned substantially within said cavity, and an extended position wherein said blade is substantially an extension of said handle;
a shroud interconnected to said upper edge of said blade proximate to said heel end, said shroud extending outwardly in at least two opposite directions from said upper edge to provide a protective shelf for a user's thumb when said knife blade is in said extended position of use, and to facilitate opening with a user's thumb when said folding knife blade is in said closed position.

14. The folding knife of claim 13, wherein said knife shroud extends outwardly from said upper edge of said knife blade on each side of said blade upper edge at least about 0.15 inches.

15. The folding knife of claim 13, wherein said shroud is positioned substantially adjacent said upper edge of said handle when said blade is in said extended position of use.

16. The folding knife of claim 13, wherein said handle further comprises a clip interconnected thereto for removably interconnecting said folding knife to an object such as an article of clothing.

17. The folding knife of claim 13, wherein said knife blade further comprises an aperture extending through said knife blade positioned substantially below said shroud, wherein said aperture and said shroud may be engaged by a user's thumb to open said knife blade from said closed position to said extended position of use.

18. The folding knife of claim 13, wherein said knife blade further comprises a hump extending upwardly from said upper edge positioned substantially adjacent said shroud for providing additional support to a user's thumb.

19. The folding knife of claim 13, wherein said shroud has a substantially oval shape.

20. The folding knife of claim 13, wherein said shroud has a substantially rectangular shape.

21. The folding knife of claim 13, wherein said shroud has an upper surface which is serrated to frictionally engage a user's thumb.

22. The folding knife of claim 13, wherein said shroud is integrally interconnected to said upper edge of said knife blade.

23. A knife blade adapted for use with a knife handle, comprising:
a pointed end, a heel end, a cutting edge and an upper end, said heel end adapted for interconnection to a forward end of the folding knife handle;
a hump extending upwardly from said upper edge of said knife blade between said pointed end and said heel end;
a shroud integrally interconnected to said upper edge of said knife blade proximate to said hump and extending outwardly in at least two opposite directions from said upper edge to create a width at least about three times a thickness of the knife blade, wherein a user's thumb may be positioned against an upper surface of said shroud when said knife blade is being used.

24. The knife blade of claim 23, further comprises a plurality of serrations positioned on said upper surface of said shroud to frictionally engage a user's thumb to inhibit sliding.

25. The knife blade of claim 23, wherein said heel end of said knife blade is rotatably interconnected to a forward end of said knife handle.

26. The knife blade of claim 25, further comprising an aperture extending through said knife blade and positioned below said shroud for further assisting the opening of said knife blade.

27. The knife blade of claim 25, further comprising a depression positioned below said shroud for further assisting the opening of said knife blade.

28. A folding knife with an integral blade thumb guard, comprising:
a handle having a front end, a rear end, an upper end and a lower end, and a cavity extending therebetween;
a blade having a front end, a heel end, an upper edge and a lower edge, said heel end rotatably interconnected to said forward end of said handle, wherein said knife blade can be rotated between a closed position with said cutting edge positioned substantially within said cavity, and an extended position wherein said blade is substantially an extension of said handle;
a shroud interconnected to said upper edge of said blade proximate to said heel end, said shroud extending outwardly in at least two opposite directions from said upper edge to provide a protective shelf for a user's thumb when said knife blade is in said extended position of use, and to facilitate opening with a user's thumb when said folding knife blade is in said closed position.
